(19) United States
(12) Patent Application Publication
(10) Pub. No.: US 2006/0235778 A1
(43) Pub. Date: Oct. 19, 2006

(54) Performance indicator selection

(76) Inventors: Nadim Razvi, Speyer (DE); Matthias Deppe, Northeim (DE); Oswald Wieser, Schwetzingen (DE); Martin Guenther, Karlsdorf-Neuthard (DE)

Correspondence Address: FISH & RICHARDSON, P.C., PO BOX 1022, MINNEAPOLIS, MN, 55440-1022, US

(21) Appl. No.: 11/108,124

(22) Filed: Apr. 15, 2005

(51) Int. Cl. G06Q 40/00

(52) U.S. Cl. 705/35

(57) ABSTRACT

Performance indicators selected for an organization. In some exemplary implementations, a system for selecting performance indicators that are relevant for an organization's business strategies includes a questionnaire tool to present questions to a Graphical User Interface (GUI) user. The system also includes a performance indicator wizard to receive responses for the questions presented in the GUI and to generate a list of recommended performance indicators and optional performance indicators for the organization.

### TECHNICAL FIELD

The following description relates to computing systems that utilize tools for enhancing strategic performance and forecasting for organizations.

### BACKGROUND

An industry is typically comprised of business entities that interact with other business entities. The business entities may include market participants who may use software tools to exchange information with other participants.

The market participants in an industry may have many business processes that are used to interact with other market participants. Business processes also include activities to achieve a specific business result.

Business results can depend, in part, on the strategies that are used to grow the business. Some business strategies may be used to increase one or more financial objectives of the organization, such as return on investment or gross margins of products and services. Other business strategies may be focused on improving communications with clients, customers, and suppliers. Some of the communication business strategies may involve decreasing customer response time, and lowering the costs of communicating with foreign suppliers. Still other business strategies may be used in improving the quality of work and human resources within the organization. For example, some human resource strategies may focus on employee satisfaction, employee performance and productivity, and employee recruitment and retention.

The business organization may need to find out what types of Strategic Performance Indicators (SPIs) or Key Performance Indicators (KPIs) should be used in determining a strategy or company forecast. KPIs may be used to show the most relevant aspects of a company's strategy, and may be used in company forecasting. For example, some KPIs may be related to human resource strategies and other KPIs may be related to the financial objectives of the company. Business organizations may need to perform an analysis of their goals and operations to decide for themselves which KPIs are the most relevant or significant for their particular business or industry.

### SUMMARY

The present application describes systems and techniques relating to software to select and recommend KPIs for organizations.

One general aspect relates to a computer program product tangibly embodied in an information carrier, the computer program product including instructions that, when executed, perform a method to select performance indicators for an organization. The method involves forming a second set of performance indicators based on one or more responses received from a user in response to a first set of questions associated with a selection criteria, in which the second set is a subset of a first set of performance indicators. The method also involves creating a resultant weight for each of the performance indicators in the first and second sets based on business priorities for the organization, ranking the performance indicators according to the resultant weight of each performance indicator, and creating a list of performance indicators from the first and second sets of performance indicators and the ranking. The created list of performance indicators includes one or more recommended performance indicators and one or more optional performance indicators for the organization.

Advantageous implementations can include one or more of the following features. The method may involve presenting a second set of questions to the user in a graphical user interface (GUI), and receiving the one or more responses from the user to respond to the second set of questions. The method may include forming a first set of performance indicators based on one or more factors. The first set of performance indicators may includes cross-industry performance indicators, in which each performance indicator includes performance indicator attributes. Each performance indicator attribute may include a performance indicator name, a performance indicator description, a performance indicator industry, a performance indicator weight, a performance indicator dimension in a balanced scorecard of the organization's priorities, a performance indicator relevance for a strategy, and/or a performance indicator relationship for the strategy.

In creating the resultant weight, the method may involve multiplying the performance indicator weight with a weight associated with a business priority. The one or more factors may include an estimate of understandability of performance indicator relevance for a product user, a relevance of business goals, an availability of benchmarks for the business goals, and a measure of performance indicator coverage of relevant business priorities.

The method may also involve using the selection criteria to form the second set of performance indicators based on a business context. The selection criteria can include a company strategy, a market environment, and an industry segment. The list of performance indicators may be presented in a graphical user interface (GUI), in which the list of performance indicators may include six recommended performance indicators and nine optional performance indicators. A business scorecard may be used in the method. The business scorecard may include business scorecard dimensions on the organization's business plans, strategic goals, and operations. Each business scorecard dimension may include a focus area that represents one or more priorities for the organization.

Another general aspect relates to a computer program product tangibly embodied in an information carrier, the computer program product including instructions that, when executed, perform a method to select performance indicators that are relevant for an organization's business strategies. The method involves receiving responses from a questionnaire in a graphical user interface (GUI), and based on the responses received, identifying an industry segment, a strategy, and a market environment for the organization. The method also involves using the identified industry segment, strategy, and market environment to select performance indicators from a cross-industry performance indicator list, and generating a ranked list of performance indicators from the selected performance indicators. The ranked list of performance indicators include a set of recommended performance indicators and a set of optional performance indicators for the organization.

Advantageous implementations can include one or more of the following features. The method may involve generating the cross-industry performance indicator list based on one or more factors. The factors can include an estimate of understandability of performance indicator relevance for a product user, a relevance of business goals, an availability of benchmarks for the business goals, and a measure of performance indicator coverage of relevant business priorities.

The method may also include creating a weight for the identified strategy based on the received responses. The performance indicators in the ranked list can be ranked according to a resultant performance indicator weight for each performance indicator. Each performance indicator can have an individual weight, and the resultant weight generated for each performance indicator may involve a multiplication of an individual performance indicator weight with the weight for the identified strategy. The instructions can use expert knowledge for the product to generate the cross-industry performance indicators for the organization.

The method may also include identifying business perspectives from a balanced scorecard of the organization's priorities, and identifying priorities for the business perspectives. Use of the balance scorecard is optional, and the balanced scorecard can include business priorities within two or more dimensions of business objectives.

In another general aspect, the disclosure relates to a system for selecting performance indicators that are relevant for an organization's business strategies. The system includes a questionnaire tool to present questions to a Graphical User Interface (GUI) user, and a performance indicator wizard to receive responses for the questions presented in the GUI and to generate a list of recommended performance indicators and optional performance indicators for the organization.

Advantageous implementations can include one or more of the following features. The system may be configured use a set of cross-industry performance indicators that are selected based on a number of factors. The factors can include a measure of understandability of user relevance of performance indicators, a relevance of business goals, an availability of benchmarks for the business goals, and a measure of performance indicator coverage of relevant business priorities.

The performance indicator wizard may be configured to select a subset of the set of cross-industry performance indicators based on a company strategy, a market environment, and an industry segment. The performance indicator wizard can also be configured to create a resultant weight for each performance indicator. Each performance indicator may have an individual weight, and the resultant weight created for each performance indicator may include a multiplication of an individual performance indicator weight with a weight for a business priority.

The recommended performance indicators may include a set of performance indicators with the highest resultant weights and the optional performance indicators may include a set of performance indicators with the highest resultant weights after the set of recommended performance indicators. The weighting of the performance indicators may be based on one or more performance indicator attributes and one or more business priorities and perspectives in a balanced scorecard. The balanced scorecard can include business priorities within two or more dimensions of business objectives.

The techniques associated with the present application offers several advantages. For example, an organization can use software to forecast company-specific performance. The forecast can use Key Performance Indicators (KPIs) (or Strategic Performance Indicators—SPIs) to show the most relevant aspects of the company's strategy. The software can help a company develop a strategy around a particular industry. The software can use a list of KPIs that are relevant to the industry of the company. The software program can also select the most relevant KPIs among the list of industry-specific Key Performance Indicators for the company. The software can generate a set of questions for the company, evaluate the company's answers to those questions, rank the KPIs according to the company's strategic objectives, and generate a list of the most relevant, company-specific KPIs. The software may use built-in expert knowledge to reduce complexity for the company in selecting KPIs based on the company's strategy and industry segment. The selected strategy may involve implementing one or more strategic tradeoffs for the company. As another benefit, by using software to select and recommend KPIs, the company may avoid performing a large assessment project to analyze business objectives and determine which KPIs are the most relevant and significant.

Details of one or more implementations are set forth in the accompanying drawings and the description below. Other features and advantages will be apparent from the description and drawings, and from the claims.

### DRAWING DESCRIPTIONS

FIG. 1A shows an exemplary system-level block diagram of the KPI environment.

FIG. 1B shows a flow diagram that illustrates selecting Key Performance Indicators (KPIs), according to one implementation.

FIG. 1C shows a diagram that illustrates examples of KPI attributes.

FIG. 1D shows a diagram that illustrates an example of factors used in KPI selection.

FIG. 1E shows a diagram that illustrates an example of a selection criteria used in KPI selection.

FIG. 1F shows a diagram that illustrates an example of a factor used for KPI selection.

FIG. 2 shows a diagram of an exemplary balanced scorecard.

FIGS. 3A-3C show flow diagrams to illustrate KPI selection, according to one implementation.

FIGS. 4-8 show exemplary graphical user interfaces (GUIs) for the KPI Wizard. Like reference symbols in the various drawings indicate like elements.

### DETAILED DESCRIPTION

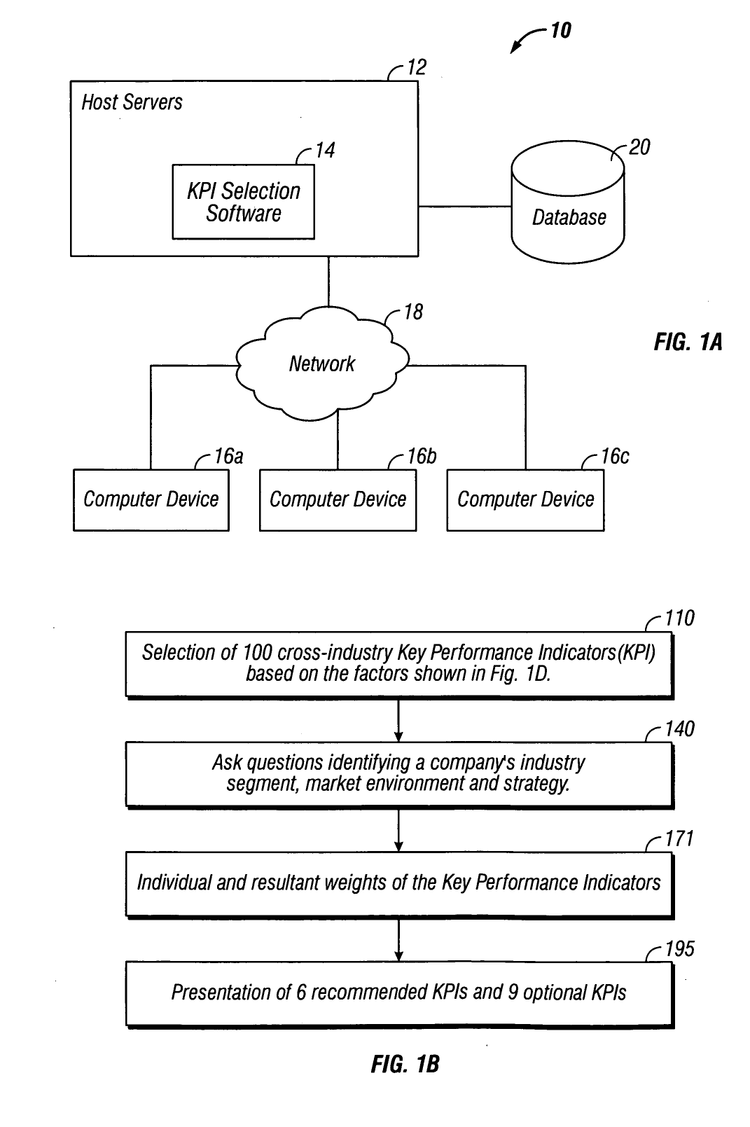

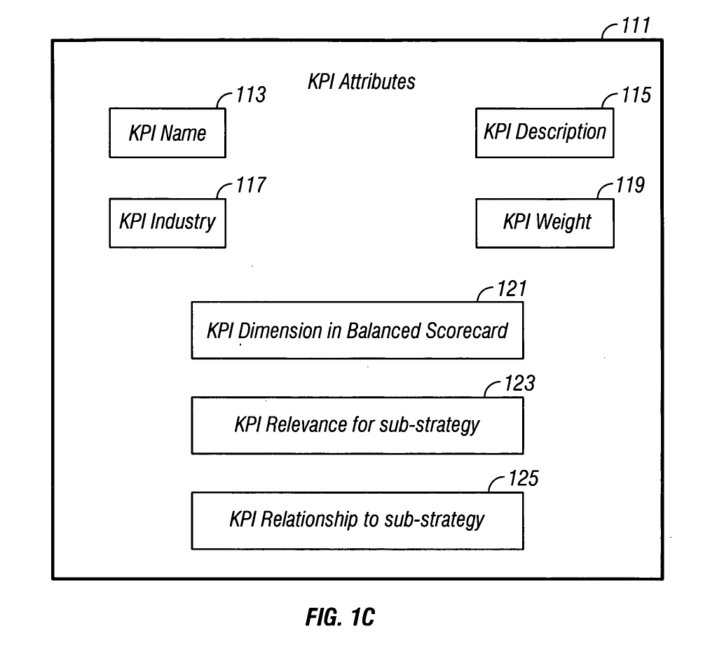

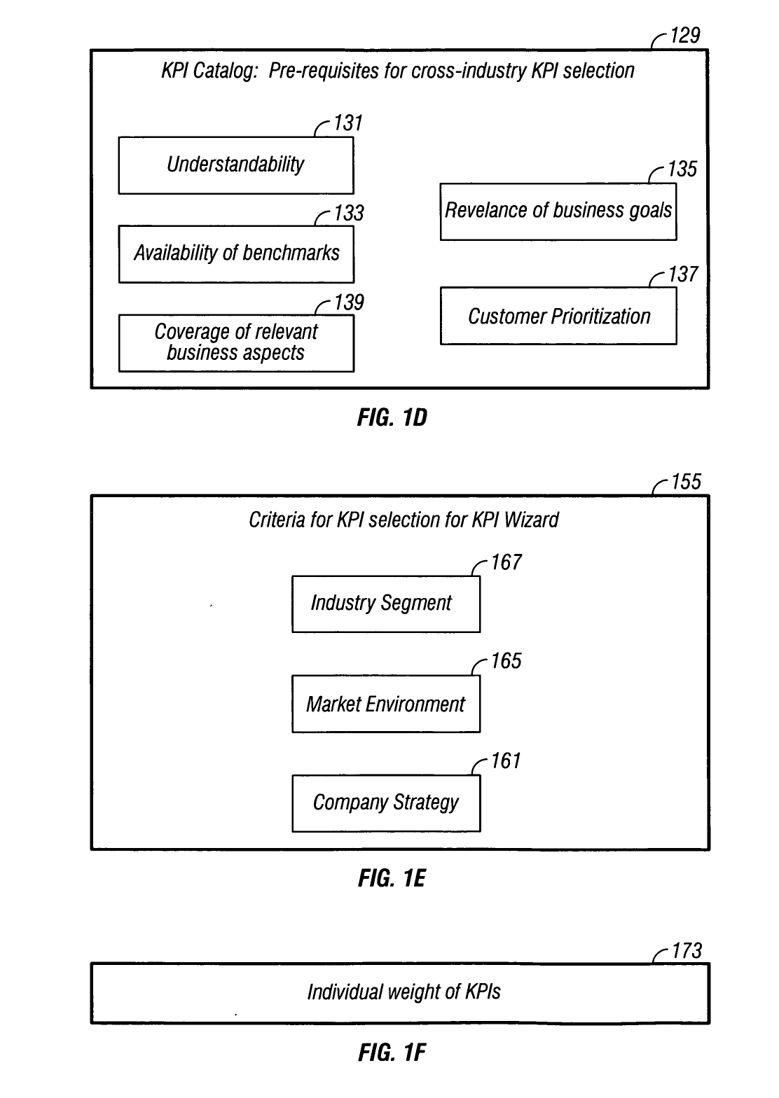

FIG. 1A is a block diagram of an embodiment of a computer system 10 that includes one or more host servers 12 for implementing the KPI Selection software 14. The software 14 can be accessed by a user using computer devices (16a, 16b, . . . 16n ) over a network 18. The host servers 12 may include, for example, an Internet-accessible server. A database 20 may be used by the host servers 12 to store and retrieve information such as information related to the operation of the host servers 12, information related to the execution of the tool 14, or other information. The software 14 presents a user with a graphical user interface (GUI) in the computer devices (16a, 16b, . . . 16n ) to enter information related to a company's business objectives, industry and goals. In some implementations, the software 14 presents a questionnaire-type GUI to the user to receive user input, and outputs a small list (e.g., five to twenty KPIs) of the most relevant KPIs for the company based on the user input. The operation of the software 14 and the KPI selection process are described in further detail below.

The software 14 may be executed in at least two modes. In an online mode, the software 14 can be distributed and executed on one or more host servers 12 and accessed by a user using a computer device such as 16a. Alternatively, in an offline mode, the user can download the software 14 onto the computer device 16 from the host servers 12 and execute the software on the computer device. The software may also be obtained through distribution channels including diskettes and CD-ROM or other such media. The network 18 may include multiple devices such as servers, routers and switching circuits connected in an intranet, extranet or Internet configuration.

A user may use a computer device, such as computer device 16a, to access the host servers 12 over a network 18. The computer device 16a may include a personal computer (PC), personal digital assistant (PDA) or other device using wireless or wired communication protocols to access the host servers 12. The computer device 16a may be coupled to I/O devices (not shown) that may include a keyboard in combination with a pointing device such as a mouse to input data into the computer, a computer display screen and/or a printer to produce output from the computer, a storage resource such as a hard disk drive for storing and retrieving data for the computer, and/or other I/O devices. The computer device 16a also my include a database (not shown) to store and retrieve data related to the execution of the software 14.

FIG. 1B shows a flow diagram that illustrates selecting Key Performance Indicators (KPIs). In some implementations, there can be a catalog of cross-industry KPIs. The software program, such as a KPI selection wizard program, can select a subset of KPIs from the set of industry-specific (or cross-industry-specific) KPIs that are focused on the company's strategic goals, market environment, industry segment, business forecasts, and project assessments. The KPI selection wizard can be based on a catalog of a number of key business performance indicators. In some implementations, there can be one hundred key business performance indicators. The KPI selection wizard can use the one hundred key business performance indicators from the catalog.

In an exemplary implementation shown in FIGS. 1A-1F, the software program selects a from catalog of KPIs and selects a set from that group that are the most relevant KPIs for the company. The software program selects from among one hundred cross-industry KPIs that are based on a first selection criteria (block 110). The first selection criteria is shown in FIG. 1D. The first selection criteria is a prerequisite for the KPI selection wizard. The KPI selection wizard can be based on a catalog of cross-industry KPIs, and the catalog may be based on various business aspects, such as understandability, availability of benchmarks, and relevance of business goals. In one exemplary implementation, 13 questions identifying a company's industry segment, market environment, and strategy may be presented to a user (block 140). The number of questions is not limited to 13 questions, but may vary. The selection criteria associated with these questions are shown in FIG. 1E. The KPIs selected are weighted and ranked according to an individual weight of the KPIs (block 171). Another selection criterion is shown in FIG. 1F, and is associated with the individual weight of the KPIs. Based on the answers to the questions (block 140) and the weighting and ranking of the KPIs based on the selection criterion (block 171), the software presents six “recommended” KPIs and nine “optional” KPIs to the company (block 195). The optional KPIs may be useful if the company decides to use KPIs in addition to the recommended KPIs.

The KPI selection wizard presents a proposal of the fifteen KPIs (six recommended KPIs and nine optional KPIs). Based on the input from the user and the calculations in the KPI selection wizard, the six recommended KPIs can represent the most relevant KPIs. The nine optional KPIs are also relevant, but may not be as relevant as the six recommended KPIs. The user can choose to select any number of the presented KPIs for the company's use.

The actual number of KPIs selected and presented with respect to FIGS. 1A-1F is not limited to the number shown in the exemplary implementation, but may vary from the number shown. In general, the software program selects from a catalog of cross-industry KPIs (block 110). Some of the cross-industry KPIs may include KPIs for cash flow, return on investment (ROI), delivery performance, unit cost, innovation rate, research and development costs, amount of product returns, capital utilization, employee training costs, and employee absenteeism. The KPI selection wizard program can use a set of related questions to pre-select a set of the KPIs from the catalog of cross-industry KPIs (block 140). The KPIs selected are weighted and ranked according to a weight of each KPI (block 171). Based on the subset of selected KPIs from the questions presented (block 140) and the weighting and ranking of the KPIs based on the weighting (block 171), the software presents a first group of recommended KPIs and a second group of optional KPIs to the company (block 195). The number of KPIs selected in the set of cross-industry KPIs can be greater than or equal to the total number of KPIs in the first group of recommended KPIs and the second group of optional KPIs.

FIG. 1C shows exemplary attributes associated with each KPI. The KPI attributes 111 include a KPI name 113 and a KPI description 115. A KPI industry 117 attribute relates a KPI to an industry for which the KPI is relevant. A KPI weight 119 attribute represents a basic weight for an individual value for the relevance of the KPI. KPI attributes also include a KPI dimension in a balanced scorecard, which are described below.

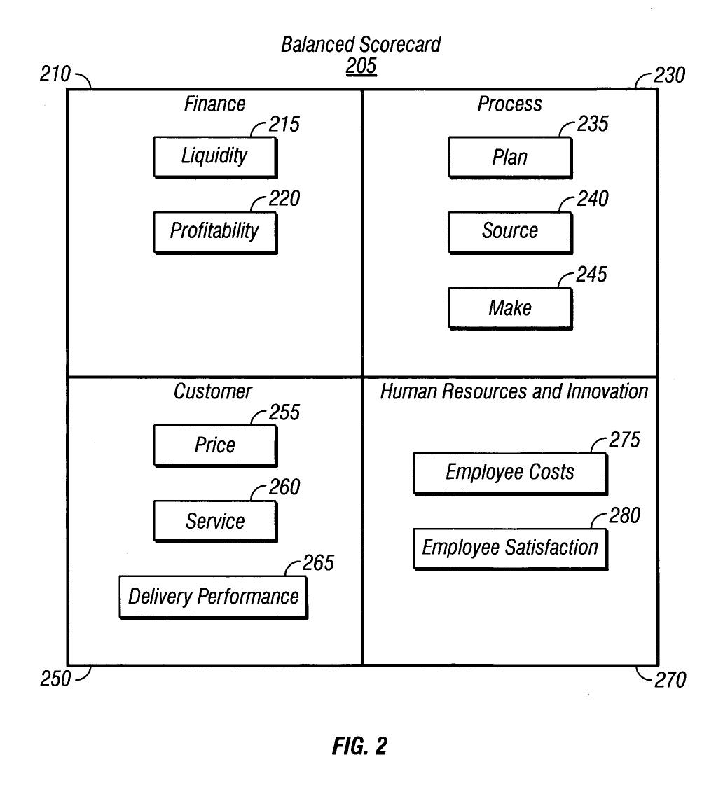

An exemplary balanced scorecard is shown in FIG. 2. The scorecard may be referred to as a balanced scorecard because the company may have to balance and weight the various focus areas in various dimensions based on the strategic goals in the company. The balanced scorecard can refer an approach to strategic management developed by Dr. Robert Kaplan and David Norton. The balanced scorecard approach can provide guidance as to what a company should measure in order to balance the company's financial perspectives. The balanced scorecard may also refer to a management system that can enable companies to help develop and implement strategies. The balancing and weighting may involve trading off and prioritizing one focus area over another focus area. The disclosed software assists in balancing and weighting the various focus areas. Each scorecard dimension may represent a perspective that is focused on the company's business plan, strategic goals, and/or operations. Each scorecard dimension can include focused areas that represent one or more priorities for the company. A balanced scorecard dimension can include strategic focus areas for a company, such as a company's processes, customer relations, and human resources.

In some implementations, the KPI selection wizard can use the balance scorecard approach to express a company's strategy. In other implementations, the KPI selection wizard does not use the balanced scorecard approach and may express the company's strategy without using the balanced scorecard.

Other KPI attributes 111 include a KPI relevance 123 for a strategy or sub-strategy, and a KPI relationship 125 to that strategy or sub-strategy. A strategy may involve a strategy for improving employee satisfaction, and a sub-strategy may involve improving employee communications.

FIG. 1D shows a diagram that illustrates an example of factors used in KPI selection. The KPI catalog factors shown can be used for selecting a group of KPIs (e.g., 100 KPIs) for cross-industry KPI selection. The factors shown in selecting the cross-industry KPIs can serve as pre-requisites for using the KPI selection wizard. The KPI selection wizard uses the catalog of cross-industry KPIs, and the catalog can be created from the five factors listed in FIG. 1D.

The KPI catalog factors 129 include an estimate of how easy it is for a software user to understand the relevance of the KPI (block 131), a relevance of business goals 135, and an availability of benchmarks 133 for the business goals. The KPI catalog factors 129 also include an indication of how well the selected KPIs covers relevant business aspects 139, and key priorities 137 that customers consider when conducting business with the company. The KPI catalog factors 129 can be used to eliminate and/or reduce non-relevant KPIs according to a company's industry segment and strategies.

The KPI catalog factors 129 can be used to select a group of KPIs from among a variety of industries or business communities. The various KPIs may involve particular participants and industry segments (e.g., importers, suppliers, OEM's, manufacturers, distributors, vendors, sellers, end-customers, insurance companies, publishing companies, service companies, paper manufacturer, retail, high tech, public service, automotive supplier), business activities (e.g., order tracking, receipt processing, production, search requests), information sharing (e.g., business documents, status reports, purchase orders), document flow features (e.g., a search for specified vehicles), employee roles (e.g., a strategic purchaser), business benefits (e.g., improved buying power, reduced delivery times, cost advantages, increased customer satisfaction), value potential (e.g., 50% increase), and business scenarios (e.g., Business to Business Scenarios, Marketplace Scenario, Customer Interaction Scenario). The KPIs may involve a specific role (e.g., an employee who purchases goods is a purchaser), information flow, and systems landscapes (e.g., roles of the systems, software components, software releases, information to exchange between each system, and functions to process exchanged information within a system).

FIG. 1E shows the a KPI selection criteria 155, in which a KPI selection wizard can pre-select a group of KPIs for a particular company based on the company's business context. The company can answer questions from the KPI wizard related to several aspects, such as industry segment 167, market environment 165, and company strategy 161. In some implementations, focus areas within a balanced scorecard and the focus perspectives may be used to express the company's strategy.

The KPI selection wizard provides built-in expert knowledge in the software program to reduce complexity for the company in choosing the most relevant KPIs. The KPI selection wizard can be a generic tool that can be used for any industry segment. In some implementations, the KPI selection tool can be pre-configured for one or more industry segments to include expert knowledge for those segments. The KPI selection criteria used for the questions presented to the user includes a company strategy 161, a market environment 165, and an industry segment 167. The market environment 165 criterion may involve indications of whether the market is a buyer's market or a seller's market, whether there are overcapacities or market crowding, and whether the market is a mature market or a developing market. The market environment 165 criterion may also involve an indication of a number of customers and a number of competitors in a market.

FIG. 1F shows the third KPI selection criterion 173, which is used when weighting and ranking the KPIs. The third KPI selection criteria 173 includes the specific weight of individual KPIs.

FIG. 2 shows an exemplary balanced scorecard 205 with four dimensions: finance 210; process 230; customer 250; and human resources and innovation 270. Each scorecard dimension 210, 230, 250, and 270 can represent a perspective that is focused on the company's business plan, strategic goals, and/or operations. Each scorecard dimension 210, 230, 250, and 270 can include focused areas that represent one or more priorities for the company. In general, the balanced scorecard may not be limited to the types and amounts of dimensions and focused areas shown, but may include other numbers and different types of dimensions and focused areas. The scorecard may be referred to as a balanced scorecard because the company may have to balance and weight the various focus areas in various dimensions based on the strategic goals in the company. The balancing and weighting may involve trading off and prioritizing one focus area of another focus area. The disclosed software assists in balancing and weighting the various focus areas. For example, a question presented by the KPI wizard may ask the user if there are focus areas, and the KPI wizard can use the input to generate a KPI short list.

In the exemplary implementation shown in FIG. 2, the finance dimension 210 has focus areas of liquidity 215 and profitability 220. The process dimension 230 has focused areas of a process plan 235, a process source 240, and a process make 245 or method of production. The process source 240 may involve resources (e.g., materials, personnel) that are needed for the process 230. The process plan 235 may involve one or more methods of production or manufacture.

A customer 250 dimension includes the focus areas of price 255, service 260, and delivery performance 265. The price 255 focus area may involve determining a target price for a good or service. The service 260 focus area may include customer feedback and measurements of customer satisfactions levels. The delivery performance 265 may involve measurements of target delivery times for goods and/or services compared with actual delivery times.

A human resource and innovation dimension 270 includes the focused areas of employee costs 275 and employee satisfaction 280. The employee costs 275 focus area may involve an amount of company resources that are needed to employ an employee in a given work task or position. The employee satisfaction 280 focus area may involve measurements of employee satisfaction in various business groups and positions within the company. Employee satisfaction 280 may also involve metrics for employee retention.

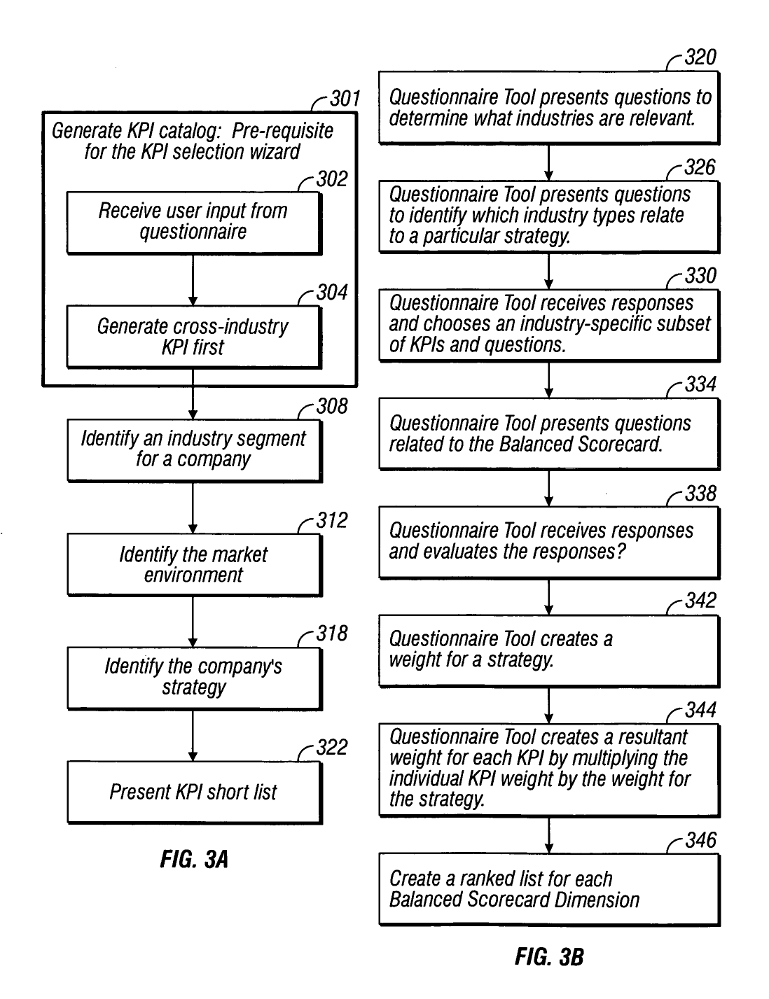

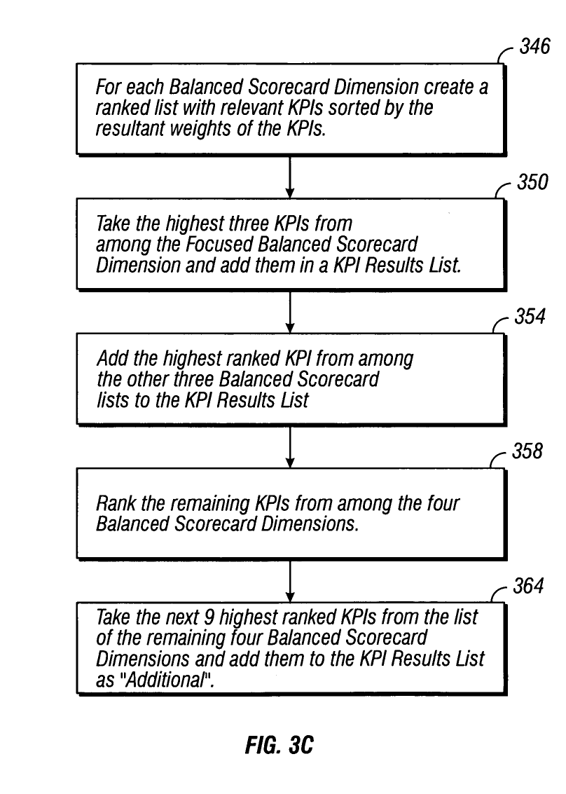

FIG. 3A shows an exemplary flow diagram that illustrates a process of selecting and prioritizing KPIs. A catalog of KPIs can be generated so that the KPI wizard can select KPIs from the catalog (block 301). In the exemplary flow diagram shown, generating a catalog of KPIs is a pre-requisite for the KPI selection wizard. The catalog generation may involve receiving user input of the questionnaire (block 302) and generating a cross-industry KPI list (block 304). In some implementation, the generation of the cross-industry KPI list may be a result of using the five factors shown in FIG. ID, and generating the catalog of cross-industry KPIs may occur prior to a user using the KPI selection wizard.

The software can present a questionnaire in a graphical interface (GUI) to a user to prompt the GUI user for answers so that the software can generate a list of KPIs that are relevant to the company, and narrow down and prioritize the list of KPIs into the most relevant KPIs for the user's company. In some implementations, the software may prompt the user for responses in a questionnaire format (block 302), and after receiving the responses, generate a KPI list that may be cross-related among several different types of industries (block 304). In other implementations, a knowledge expert may create a catalog of cross-industry KPIs based on the five factors shown in FIG. 1D.

For example, after receiving a completed questionnaire from a microchip company, a cross-industry KPI list may be generated across several industries, such as the computer industry, cellular phone industry, optical device industry, educational services industry, retail distribution industry, customer call center industry, office supplies industry, and electronic publications industry. The industry segment for the company is identified and generated (block 308), such as identifying the computer industry for the microchip company. A market environment for the company may be identified (block 312). For example, the microchip company may have to finish design for a microchip by a certain date in order for the microchip to be located within particular products by the holiday shopping season. If the microchip company misses a certain deadline then the market environment may change and there may no longer be a great demand for the product. The software can identify the company's strategy (block 318). Focus areas within the balanced scorecard and the focus perspectives may be used to express the company's strategy. At least one individual focused perspective is identified based on the balanced scorecard. For example, the focused perspective may involve reorganizing a group of employees to form a design team. The software then presents a shorter, narrowed-down list of the most relevant KPIs to the user (block 322). The most relevant KPIs may be ranked based on the priorities and perspectives in the balanced scorecard.

FIGS. 3B-3C illustrate another technique for KPI selection. A questionnaire tool of the software product presents questions of what industries are relevant to the company (block 320). The questionnaire tool presents questions to identify which industry types relate to a particular strategy (block 326). The tool receives the responses and chooses an industry-specific subset of KPIs and related questions (block 330). The tool then presents questions related to the balanced scorecard (block 334) and evaluates the received responses (block 338).

The questionnaire tool may have a set of associated rules. For example, the user may be required to respond to a minimum number of questions before the questionnaire tool moves to the next step in creating a strategy and/or recommending KPIs. In other implementations, some questions may require mandatory responses from the user and other questions may have optional responses from the user.

In some implementations, the questionnaire tool may evaluate a number of “yes” or “no” responses to questions for a particular strategy. The questionnaire tool creates a weight for the strategy (block 342). For example, the tool can create a weight for a particular strategy, Strategy A, with the following formula: Strategy weight for Strategy A=100*(Total number of responses for Strategy A)/(Total number of responses from all strategies).

The questionnaire tool creates a resultant weight for each KPI by multiplying the individual KPI weight by the weight for the strategy (block 344). In one example for Strategy A, a resultant weight for KPI_i can be calculated by the following formula: Resultant KPI for KPI_i=(KPI_i weight) *(Strategy weight for Strategy A).

For each balanced scorecard dimension a ranked list is created with relevant KPIs sorted by the resultant weight of the KPIs (block 346). The strategy from the questionnaire tool can relate to a focus area for a dimension from the balanced scorecard. The three highest ranked KPIs from the most relevant dimension, the Focused Balanced Scorecard Dimension, are added an a KPI Results List (block 350). The highest ranked KPI from among the other three balanced scorecard lists is added to the KPI Results List (block 354). The remaining KPIs from among the four balanced scorecard dimensions are then ranked in a list based on their respective resultant KPI weight (block 358). The remaining KPIs represent the KPIs that have not been added to the KPI Results list (as of block 358). The next nine highest ranked remaining KPIs from the list of the four balanced scorecard dimensions are then added to the KPI Results List as “Additional” KPIs (block 364). The KPI Results List includes 15 KPIs, with the six highest-ranked KPIs representing “recommended KPIs”, and the 9 following KPIs representing “optional KPIs.” The software allows the user to activate or deactivate any of the KPIs in the KPI Results List. The actual number of KPIs in the KPI Results List are not limited to the amount described with respect to FIGS. 3B-3C, but many be a list with a different number of KPIs and/or a different number of recommended or optional KPIs.

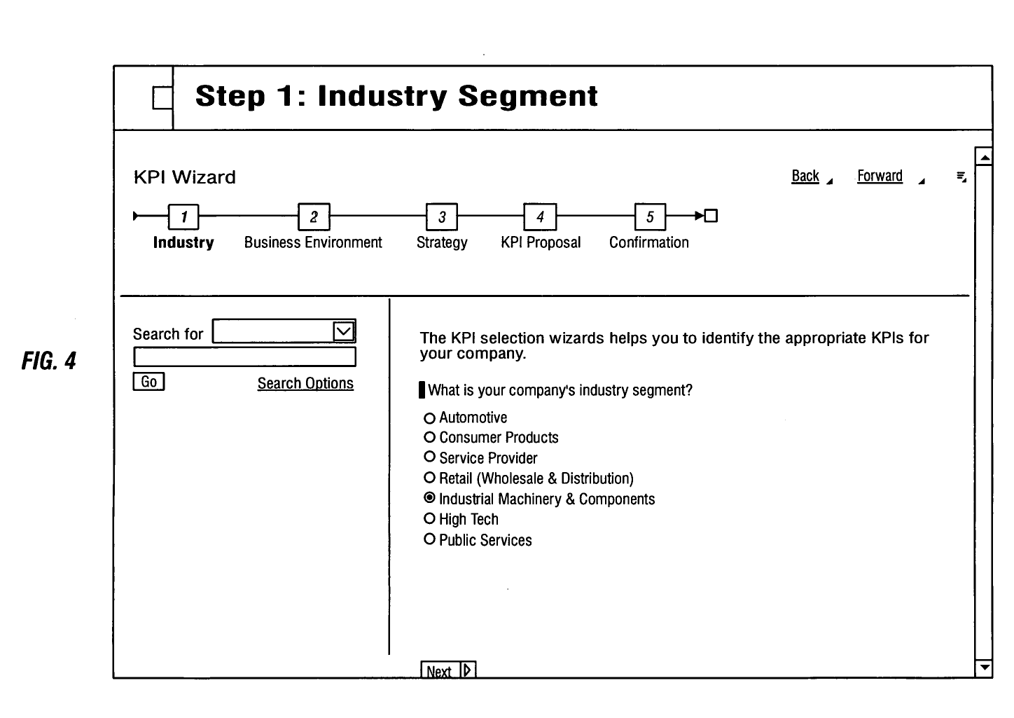

FIG. 4 shows an exemplary diagram of a graphical user interface (GUI) 400 for the KPI selection wizard tool to identify a particular industry for the company. For example, GUI 400 can ask one or more questions on the company's industry segment to determine appropriate KPI's for the company. The GUI 400 can be used in conjunction with the KPI Wizard to help to select relevant KPIs and narrow a number of potential KPIs into the most relevant KPIs based on the responses received from the questionnaire.

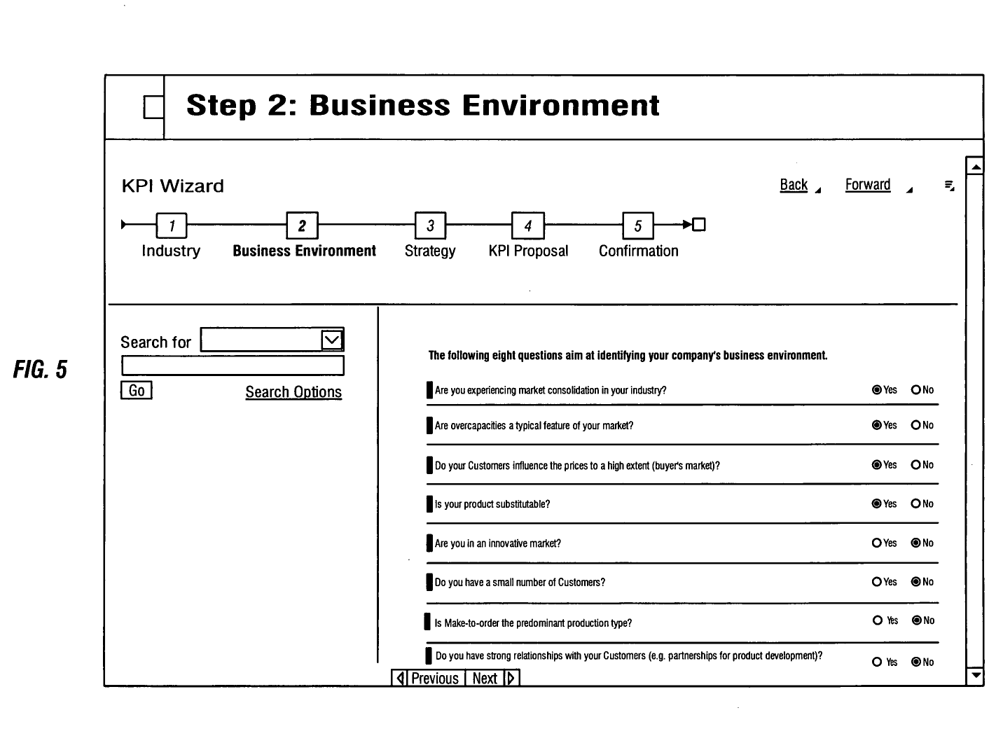

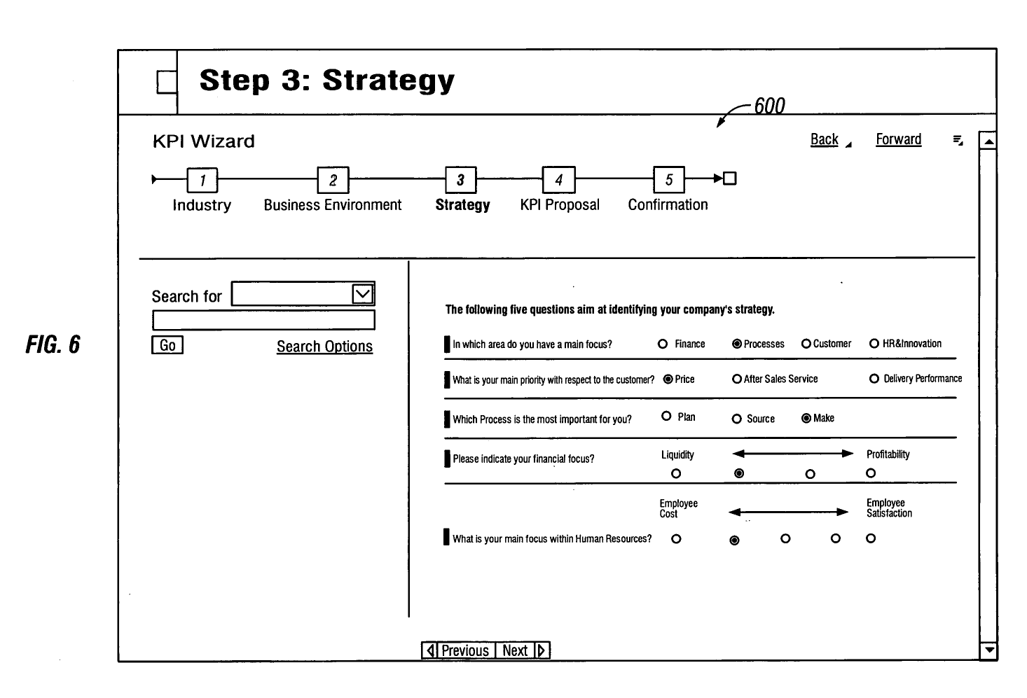

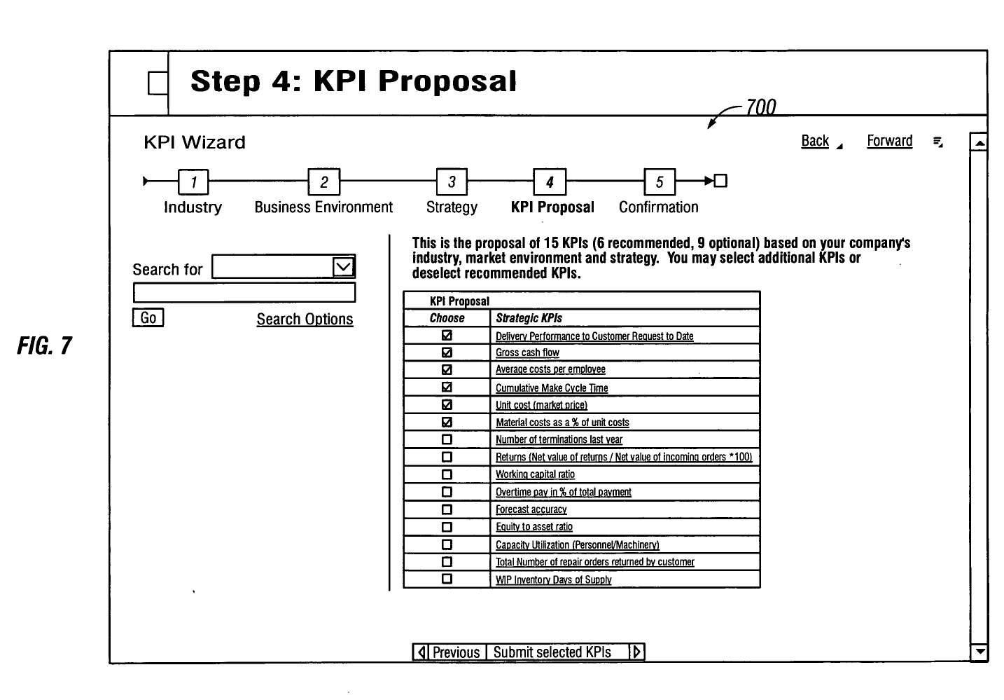

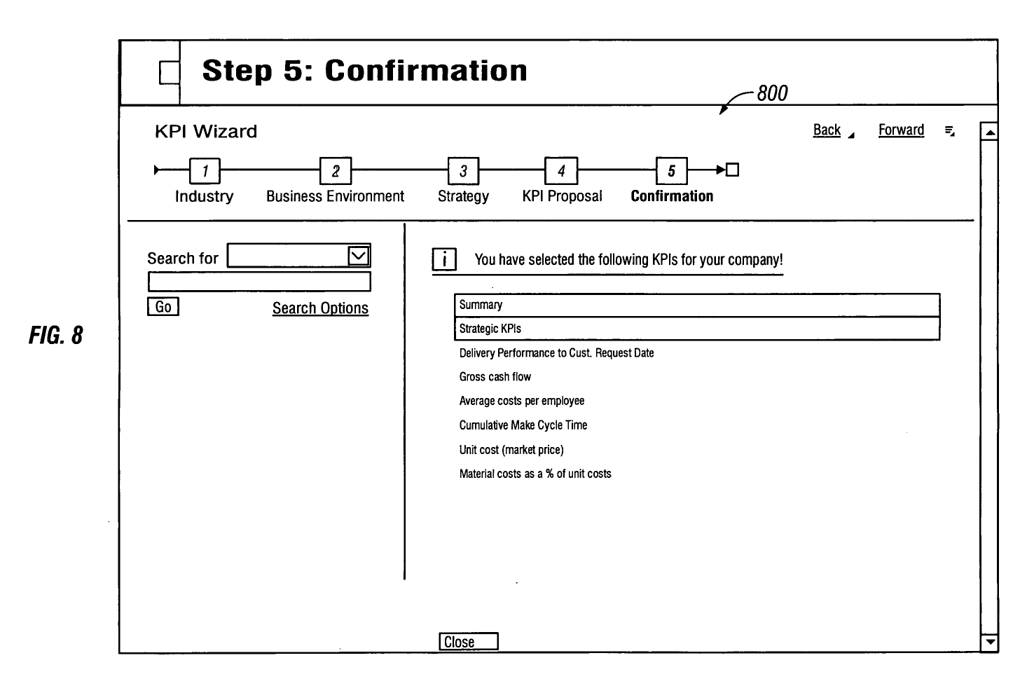

FIG. 5 shows an exemplary diagram of a graphical user interface (GUI) 500 for the KPI selection wizard tool to identify a business environment. The GUI 500 can present a series of “yes” or “no” questions to the user, as well as questions relating to focus areas, priorities and markets. FIG. 6 shows an exemplary diagram of a graphical user interface (GUI) 600 for the KPI selection wizard tool to identify the company's strategy. The GUI 600 can present a series of “yes” or “no”. questions to the user, as well as questions multiple choice questions. FIG. 7 shows an exemplary diagram of a graphical user interface (GUI) 700 for the KPI selection wizard to present the proposed KPIs to the user. The GUI 700 can present 9 optional KPIs and 6 recommended KPIs to the user and allow the user to select or deselect proposed KPIs. FIG. 8 shows an exemplary diagram of a graphical user interface (GUI) 800 for the KPI selection wizard to present a confirmation page of the selected KPIs to the user.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

The software (also known as programs, software tools or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor. In one implementation, a computer program product is tangibly embodied in an information carrier. The computer program product contains instructions that, when executed, perform a method, such as one of the methods described above. The information carrier is a computer- or machine-readable medium, such as memory, or a storage device.

To provide for interaction with a user, the systems and techniques described here can be implemented on one or more computers each having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input. The components of the system can be interconnected by any form or medium of digital data communication (e.g., a communication network). Examples of communication networks include a local area network (“LAN”), a wide area network (“WAN”), a wireless local area network (“WLAN”), a personal area network (“PAN”), a mobile communication network using a multiple access technology (e.g., a cellular phone network with Code Division Multiple Access, “CDMA”), and the Internet.

The computing system shown in FIG. 1A can include clients and servers. A client and server are generally remote from each other and typically interact through a communication network. The relationship of client and server arises by virtue of computer programs running on the respective computers and having a client-server relationship to each other.

Although only a few implementations have been described in detail above, other modifications are possible. There may be other communication scenarios not described. For example, the questionnaire tool may send out questionnaires to multiple users in an organization and create an single response for each question to represent the response for the organization. In some implementations, the software can weigh the respective received responses based on the status and role of the user. The particular order shown in the flowcharts may vary from the order shown and similar results may be achieved. Other implementations may be within the scope of the following claims.

What is claimed is:

1. A computer program product tangibly embodied in an information carrier, the computer program product including instructions that, when executed, perform a method to select performance indicators for an organization, the method comprising:
forming a second set of performance indicators based on one or more responses received from a user in response to a first set of questions associated with a selection criteria, wherein the second set is a subset of a first set of performance indicators;
creating a resultant weight for each of the performance indicators in the first and second sets based on business priorities for the organization;
ranking the performance indicators according to the resultant weight of each performance indicator; and
creating a list of performance indicators from the first and second sets of performance indicators and the ranking, wherein the list of performance indicators comprises one or more recommended performance indicators and one or more optional performance indicators for the organization.

2. The product of claim 1, wherein the method further comprises:
presenting a second set of questions to the user in a graphical user interface (GUI); and
receiving the one or more responses from the user to respond to the second set of questions.

3. The product of claim 1, wherein the method further comprises forming a first set of performance indicators based on one or more factors.

4. The product of claim 3, wherein the first set of performance indicators comprises cross-industry performance indicators, wherein each performance indicator comprises performance indicator attributes, and wherein each performance indicator attribute comprises a performance indicator name, a performance indicator description, a performance indicator industry, a performance indicator weight, a performance indicator dimension in a balanced scorecard of the organization's priorities, a performance indicator relevance for a strategy, or a performance indicator relationship for the strategy.

5. The product of claim 4, wherein creating the resultant weight comprises multiplying the performance indicator weight with a weight associated with a business priority.

6. The product of claim 5, wherein the one or more factors comprises an estimate of understandability of performance indicator relevance for a product user, a relevance of business goals, an availability of benchmarks for the business goals, and a measure of performance indicator coverage of relevant business priorities.

7. The product of claim 6, wherein the method further comprises using the selection criteria to form the second set of performance indicators based on a business context.

8. The product of claim 7, wherein the selection criteria includes a company strategy, a market environment, and an industry segment.

9. The product of claim 8, wherein the method further comprises presenting the list of performance indicators in a graphical user interface (GUI).

10. The product of claim 9, wherein the list of performance indicators comprise six recommended performance indicators and nine optional performance indicators.

11. The product of claim 9, wherein the business scorecard comprises business scorecard dimensions on the organization's business plans, strategic goals, and operations, and where each business scorecard dimension comprises a focus area that represents one or more priorities for the organization.

12. A computer program product tangibly embodied in an information carrier, the computer program product including instructions that, when executed, perform a method to select performance indicators that are relevant for an organization's business strategies, the method comprising:
receiving responses from a questionnaire in a graphical user interface (GUI);
based on the responses received, identifying an industry segment, a strategy, and a market environment for the organization;
using the identified industry segment, strategy, and market environment to select performance indicators from a cross-industry performance indicator list; and
generating a ranked list of performance indicators from the selected performance indicators, wherein the ranked list of performance indicators comprise a set of recommended performance indicators and a set of optional performance indicators for the organization.

13. The product of claim 12, wherein the method further comprises generating the cross-industry performance indicator list based on one or more factors, the factors comprising an estimate of understandability of performance indicator relevance for a product user, a relevance of business goals, an availability of benchmarks for the business goals, and a measure of performance indicator coverage of relevant business priorities.

14. The product of claim 13, wherein the method further comprises creating a weight for the identified strategy based on the received responses.

15. The product of claim 14, wherein the performance indicators in the ranked list are ranked according to a resultant performance indicator weight for each performance indicator, wherein each performance indicator has an individual weight, and wherein the resultant weight generated for each performance indicator comprises a multiplication of an individual performance indicator weight with the weight for the identified strategy.

16. The product of claim 15, wherein the instructions use expert knowledge for the product to generate the cross-industry performance indicators for the organization.

17. The product of claim 15, wherein the method further comprises:
identifying business perspectives from a balanced scorecard of the organization's priorities; and
identifying priorities for the business perspectives, wherein the balanced scorecard comprises business priorities within two or more dimensions of business objectives.

18. A system for selecting performance indicators that are relevant for an organization's business strategies, the system comprising:
a questionnaire tool to present questions to a Graphical User Interface (GUI) user; and
a performance indicator wizard to receive responses for the questions presented in the GUI and to generate a list of recommended performance indicators and optional performance indicators for the organization.

19. The system of claim 18, wherein the system is configured to use a set of cross-industry performance indicators based on a plurality of factors, wherein the plurality of factors comprise a measure of understandability of user relevance of performance indicators, a relevance of business goals, an availability of benchmarks for the business goals, and a measure of performance indicator coverage of relevant business priorities.

20. The system of claim 19, wherein the performance indicator wizard is configured to select a subset of the set of cross-industry performance indicators based on a company strategy, a market environment, and an industry segment.

21. The system of claim 20, wherein the weighting of the performance indicators are based on one or more performance indicator attributes and one or more business priorities and perspectives in a balanced scorecard, and wherein the balanced scorecard comprises business priorities within two or more dimensions of business objectives.

22. The system of claim 20, wherein the performance indicator wizard is configured to create a resultant weight for each performance indicator, wherein each performance indicator has an individual weight, and wherein the resultant weight created for each performance indicator comprises a multiplication of an individual performance indicator weight with a weight for a business priority.

23. The system of claim 22, wherein the recommended performance indicators comprise a set of performance indicators with the highest resultant weights and the optional performance indicators comprise a set of performance indicators with the highest resultant weights after the set of recommended performance indicators.
